(19) United States
(12) Patent Application Publication
(10) Pub. No.: US 2024/0232090 A1
(43) Pub. Date: Jul. 11, 2024

(54) MULTI-TRAINED SCALABLE PREFETCHER, AND RELATED METHODS

(71) Applicant: Ampere Computing LLC, Santa Clara, CA (US)

(72) Inventors: Benjamin Crawford Chaffin, Santa Clara, CA (US); Mahesh Jagdish Madhav, Santa Clara, CA (US); Aarti Chandrashekhar, Santa Clara, CA (US)

(21) Appl. No.: 18/409,545

(22) Filed: Jan. 10, 2024

Related U.S. Application Data
(60) Provisional application No. 63/438,358, filed on Jan. 11, 2023.

(51) Int. Cl. G06F 12/0862

(52) U.S. Cl. CPC G06F 12/0862

(57) ABSTRACT

A multi-trained scalable prefetcher generates speculative prefetch requests to memory addresses based on address offsets generated by various address offset generators. A best offset generator provides the best address offset to a prefetch generator. At least one additional address offset generator provides at least a second address offset to the prefetch generator. The least one additional address offset generator may be a second-best offset generator. In another aspect, a number of prefetch requests generated by the multi-trained scalable prefetcher may be scaled in response to an indication of an activity level on a data interface. Scaling the number of prefetch requests may include not providing any prefetch requests to a prefetch request buffer if a data interface activity level is too high. Scaling may include increasing or decreasing a number of prefetch requests based on priority levels of the address offset generators and the data interface activity level.

### PRIORITY CLAIM

The present application claims priority to U.S. Provisional Patent Application Ser. No. 63/438,358, filed on Jan. 11, 2023, and entitled “MULTI-TRAINED SCALABLE PREFETCHER, AND RELATED METHODS,” which is hereby incorporated herein by reference in its entirety.

### FIELD OF THE DISCLOSURE

The technology of the disclosure relates to computing systems employing a cache system having at least two levels and a prefetcher for issuing speculative memory fetches.

### BACKGROUND

Computer processors or processor cores (“processors”) can execute many instructions per second. If instructions and/or the data processed by the instructions (both referred to here as “data”) are not supplied to the processor when they are needed, the processor may be forced to sit idle while waiting for the needed data. For this reason, a memory system associated with the processor includes a small first-level (L1) cache memory to store copies of data currently being used or expected to be used by the processor. The L1 cache is located close to the processor so that data can be quickly read and written. When the processor requests information from a memory location for which there is no copy in the L1 cache memory, a memory request is made to a second-level (L2) cache type of memory. The L2 cache is typically larger and takes longer to access than the L1 cache. If the L2 cache has the data that satisfies the memory request, the data can be quickly provided to the L1 cache and the processor. On the other hand, if the L2 cache does not have a copy of the requested data, the processor is forced to wait for the memory system to access a higher-level cache or external memory in the memory system.

A prefetcher may be employed in a memory system cache to anticipate the data that the processor will need based on data that has been previously fetched from memory. In other words, based on the addresses of instructions and data that the processor previously fetched, the prefetcher can request, from a higher-level memory or external memory, the contents (e.g., a cache line) of the next memory addresses expected to be accessed. Ideally, a prefetcher can minimize or eliminate idle time in the processor by ensuring that the data needed by the processor is available in the L2 cache when it is requested by the L1 cache. However, correctly identifying the instructions and data that will be accessed next may be difficult or impossible. As a result, the prefetcher may guess incorrectly, prefetching data that is not needed and causing the processor to be idle, which wastes processor bandwidth. For this reason, prefetchers are sometimes disabled by users because they can guess wrong too frequently and provide no performance improvement.

### SUMMARY

Aspects disclosed herein include a multi-trained scalable prefetcher. Related methods and computer-readable media are also disclosed. Data stored in a cache may have been demand requested by a processor or speculatively prefetched based on previously requested data. An exemplary multi-trained scalable prefetcher generates speculative prefetch requests to memory addresses based on address offsets generated by various address offset generators. The multi-trained scalable prefetcher includes a best address offset generator that keeps track of how successful address offsets, from a set of address offsets, would have been for prefetching data requested by a processor based on addresses of data previously fetched by the processor. The best offset generator provides the best address offset to a prefetch generator. The multi-trained scalable prefetcher also includes at least one additional address offset generator that provides at least a second address offset to the prefetch generator. In one example, the multi-trained scalable prefetcher includes a second-best offset generator that determines a second-best offset address based on the set of address offsets.

In another aspect, a number of prefetch requests generated by the multi-trained scalable prefetcher may be scaled in response to an indication of an activity level on a data interface. For example, scaling the number of prefetch requests may include the prefetch generator not providing any prefetch requests to a prefetch request buffer if the level of activity on the data interface is too high. Alternatively, scaling includes increasing or decreasing a number of prefetch requests provided to the prefetch request buffer based on priority levels of the address offset generators and the indicated activity level. For example, prefetch requests based on address offsets from lower priority address offset generators may be paused when the activity level on the data interface exceeds a threshold, while prefetch requests based on address offsets from higher priority address offset generators continue to be provided to the prefetch request buffer. As an example, the indication of activity level of the data interface may be a CBUSY signal.

In this regard, in one exemplary aspect, a memory system is provided. The memory system includes a prefetcher generator configured to receive a first memory address of requested data, generate a first plurality of address offsets, and generate a first plurality of prefetch requests directed to one or more prefetch addresses, each of the one or more prefetch addresses based on the first memory address and a corresponding one of the first plurality of address offsets.

In another exemplary aspect, a method of generating prefetch requests to a prefetch buffer in a memory system is disclosed. The method includes receiving a first memory address of requested data, generating a first plurality of address offsets, and generating a first plurality of prefetch requests directed to one or more prefetch addresses, each of the one or more prefetch addresses based on the first memory address and a corresponding one of the first plurality of address offsets.

In another exemplary aspect, a non-transitory computer-readable medium is disclosed. The non-transitory computer-readable medium includes having stored thereon computer-executable instructions which, when executed by a processor, cause a memory system to receive a first memory address of requested data: generate a first plurality of address offsets: and generate a first plurality of prefetch requests directed to one or more prefetch addresses, each of the one or more prefetch addresses based on the first memory address and a corresponding one of the first plurality of address offsets.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a block diagram of a prefetcher that determines offsets for data prefetch requests based on whether previously prefetched data is accessed by a processor:

FIG. 2 is a block diagram of an exemplary multi-trained scalable prefetcher that generates a scalable number of prefetch requests from multiple prefetch generators to reduce cache misses:

FIG. 3 is a flowchart illustrating the method of generating prefetch requests based on a plurality of address offsets in the multi-trained scalable prefetcher in FIG. 2:

FIG. 4 is a block diagram of a processing system, including the multi-trained scalable prefetcher of FIG. 2 that can improve processor performance by reducing a number of cache misses: and

FIG. 5 is a block diagram of an exemplary computer system that includes a processor that includes a plurality of CPU cores and peripheral devices, and other resources, including a memory system, accessing through an internal coherent fabric bus, wherein the memory system supports address range memory mirroring.

### DETAILED DESCRIPTION

Aspects disclosed herein include a multi-trained scalable prefetcher. Related methods and computer-readable media are also disclosed. Data stored in a cache may have been demand requested by a processor or speculatively prefetched based on the previously requested data. An exemplary multi-trained scalable prefetcher generates speculative prefetch requests to memory addresses based on address offsets generated by various address offset generators. The multi-trained scalable prefetcher includes a best address offset generator that keeps track of how successful address offsets, from a set of address offsets, would have been for prefetching data requested by a processor based on addresses of data previously fetched by the processor. The best offset generator provides the best address offset to a prefetch generator. The multi-trained scalable prefetcher also includes at least one additional address offset generator that provides at least a second address offset to the prefetch generator. In one example, the multi-trained scalable prefetcher includes a second-best offset generator that determines a second-best offset address based on the set of address offsets.

In another aspect, a number of prefetch requests generated by the multi-trained scalable prefetcher may be scaled in response to an indication of an activity level on a data interface. For example, scaling the number of prefetch requests may include the prefetch generator not providing any prefetch requests to a prefetch request buffer if the level of activity on the data interface is too high. Alternatively, scaling includes increasing or decreasing a number of prefetch requests provided to the prefetch request buffer based on priority levels of the address offset generators and the indicated activity level. For example, prefetch requests based on address offsets from lower priority address offset generators may be paused when the activity level on the data interface exceeds a threshold, while prefetch requests based on address offsets from higher priority address offset generators continue to be provided to the prefetch request buffer. As an example, the indication of activity level of the data interface may be a CBUSY signal.

A prefetcher generates a prefetch request for data that a processor will likely need in the near future. A prefetcher determines, based on a memory address of a fetch issued by a processor, one or more memory addresses likely to be fetched next. Accurate prefetching can ensure that the next data needed by the processor is available before it is requested by the processor, which reduces processor idle time and improves performance. Instructions executed by a processor are often stored in a predictable order (e.g., sequential). Instructions executed by a processor may also access data from a predictable pattern of memory addresses. A prefetch request is directed to a prefetch address based on the most recently fetched memory address. One or more prefetch addresses may be determined by adding one or more address offsets to the fetched memory address. The algorithm employed in the prefetcher may determine an address offset, which is an offset from the address of the most recently fetched data to the address of data that should be prefetched according to a pattern, for example. The prefetch address can be determined speculatively based on adding the address offset to the fetched memory address.

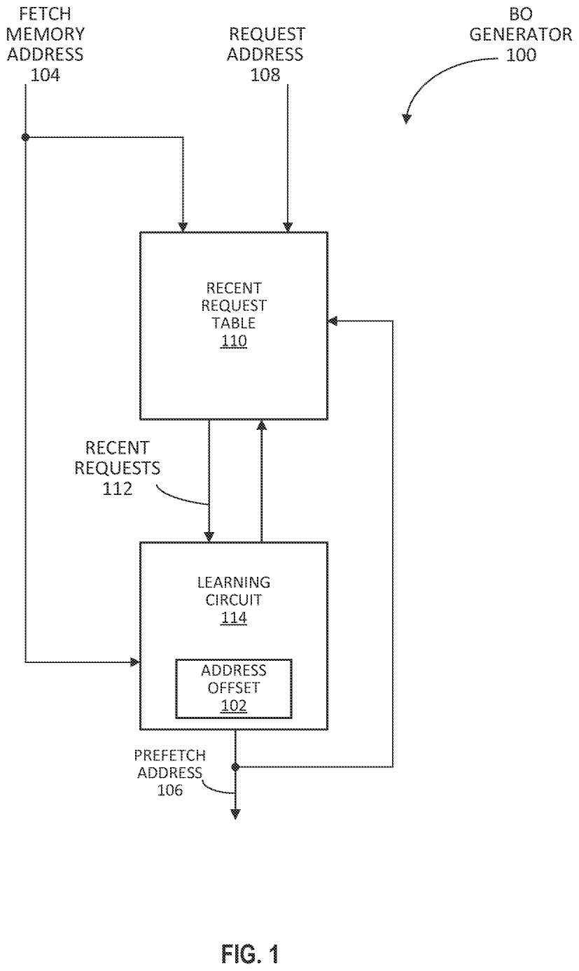

FIG. 1 is a block diagram illustrating an example of a conventional best-offset (BO) generator 100 that may be employed in a prefetcher in a memory system to determine a best address offset 102. When the BO generator 100 receives a fetch memory address 104 of a new data request from the processor, the BO generator 100 generates a prefetch address 106 based on the fetch memory address 104 of the new data request and the best address offset 102. The BO generator 100 provides the prefetch address 106 to a prefetch generator (not shown) that generates a prefetch request for data at the prefetch address 106.

The best address offset 102 is determined as follows. The BO generator 100 receives request addresses 108, which are the memory addresses of data that has been retrieved by a prefetch request and determines the memory address of a fetch that triggered the prefetch request. These memory addresses of recently requested data are stored in a recent request table 110. The memory addresses, referred to herein as recent requests 112, are provided to a learning circuit 114. The learning circuit 114 determines which address offset, of a predetermined set of address offsets, would have most likely caused a prefetch request to the new fetch memory address 104 based on the recent requests 112 in the recent request table 110.

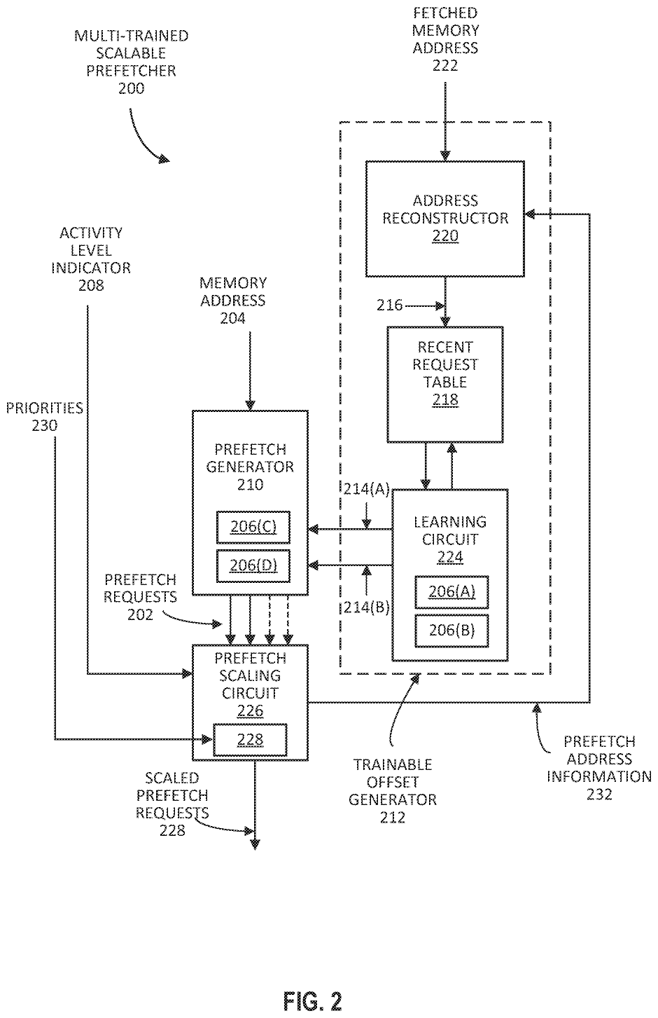

FIG. 2 is a diagram of an exemplary multi-trained scalable prefetcher 200 that generates potential prefetch requests 202 to a plurality of prefetch addresses based on a memory address 204 recently accessed by a processor and a plurality of address offsets generated by offset generators 206(A)-206(D), according to their respective offset generation algorithms. The offset generators 206(A)-206(D) are referred to collectively as the offset generators 206. In this example, up to four (4) potential prefetch requests 202 may be generated based on each accessed memory address 204. The potential prefetch requests 202 are designated as “potential” prefetch requests because a number of them that are ultimately provided to a prefetch request buffer (not shown) in response to a (recently) accessed memory address 204 may be scaled (e.g., adjusted up and down) according to an activity level indicator 208 that indicates an activity level (e.g., how busy) of a data interface over which the prefetch request buffer may transmit the potential prefetch requests 202.

The multi-trained scalable prefetcher 200 may generate the plurality of potential prefetch requests 202 to prefetch data from a higher-level cache or a memory into a lower-level cache closer to a processor. For example, the multi-trained scalable prefetcher 200 may be employed in a second level (L2) cache to increase the probability that data requested by the processor will be speculatively prefetched and available in the L2 cache for low latency access before it is requested by the processor. Having the requested data already available in this manner can reduce or eliminate a number of clock cycles in which the processor would otherwise be stalled while waiting for the data to be retrieved from the memory system.

For example, a processor may first submit a demand request for data in response to a read or write instruction executed in the processor. The request and an accessed memory address may first be received by a first-level (L1) cache. If the data corresponding to the accessed memory address is not found in the L1 cache, the L1 cache generates an L1 miss indication. In response to the miss indication, the request may be forwarded to an L2 cache to see if the requested data is stored there. If the multi-trained scalable prefetcher 200 has already prefetched the requested data and stored it in the L2 cache, an L2 hit indication is generated, and the data is provided to the processor. Alternatively, the requested data may not be stored in the L2 cache, so an L2 miss indication is generated. In response to the L2 miss, a request for data at the accessed memory address is sent to a higher level (e.g., L3) cache or a memory in the memory system.

The L2 cache may also keep track (e.g., using a “prefetch bit”) of whether data stored in the L2 cache was prefetched but has not yet been accessed by the processor. When the processor (or the L1 cache associated with the processor) issues a request for data and the L2 cache generates an L2 miss or indicates both that there is a hit and the prefetch bit is set, the multi-trained scalable prefetcher 200 is configured to generate a plurality of potential prefetch requests 202 based on the accessed memory address 204. The potential prefetch requests 202 are directed to addresses that may be storing data that the processor will request soon. For example, the processor may fetch an uninterrupted series of data or instructions at consecutive memory addresses. In such circumstances, soon after data at a cache line X is requested, the processor may request data at a cache line X+1.

In other situations, the processor may not consistently access data sequentially or at a consistent rate. In addition, the processor may branch to a non-consecutive memory address to access new instructions or data in non-consecutive memory locations. Therefore, it is difficult to accurately predict, with regularity, which memory addresses the processor will access next. For this reason, rather than sending out only one prefetch request to a first address in response to a request to an accessed memory address 204, a prefetch generator 210 may generate potential prefetch requests 202 based on address offsets from the plurality of offset generators 206, where each potential prefetch request 202 may be directed to a different memory address.

Each of the potential prefetch requests 202 is generated by adding an address offset to the accessed memory address 204 of the current request if the request results in a miss or in a hit with the prefetch bit set (e.g., in the L2 cache). In this regard, a plurality of prefetch requests are generated based on multiple address offsets, and the address offsets are generated by the offset generators 206, each of which employs a distinct respective algorithm.

A first example of the offset generator is a trainable offset (TO) generator 212, which may correspond in some aspects to the BO generator 100 described with reference to FIG. 1. As in the BO generator 100, the TO generator 212 also generates a best address offset r(A) among a predetermined set of address offsets. Thus, the TO generator 212 may include the offset generator 206(A), which may also be referred to as the BO generator 206(A). The set of address offsets may include a series of incrementally increasing offsets based on, for example, the amount of data received in response to each data request (e.g., fetch) and on the number of cycles of latency between generating a potential prefetch request 202 and receiving the requested data (e.g., into the L2 cache) from the memory system. The set of address offsets used by the TO generator 212 may be programmable and may be updated depending on an application being executed and/or one or more other considerations, for example. In addition, the set of address offsets employed by the TO generator 212 to determine the best address offset 214(A) may include address offsets generated by one or more of the other offset generators 206(B)-206(D). In this regard, the multi-trained scalable prefetcher 200 may be “trained” by multiple different offset generators 206 to determine the best address offset 214(A).

The memory addresses 216 of recently prefetched data are stored in a recent request table 218 in the TO generator 212 for use by the BO generator 206(A). The memory addresses 216 are generated in an address reconstructor 220 and provided to the recent request table 218. When the data fetched by a potential prefetch request 202 is received and stored (e.g., in the L2 cache), a fetched memory address 222 of the fetched data is provided to the address reconstructor 220. The address reconstructor 220 removes the address offset 214 from the fetched memory address 222 of the potential prefetch request 202 to determine the memory address 216 on which the potential prefetch request 202 was based. The memory addresses 216 may be a list of recently received accessed memory addresses 204. Reconstructing the memory address 216 depends on which address offset was used to generate the prefetch address of the potential prefetch request 202. In other words, the address reconstructor 220 needs information about which address offset 214 was used to generate the potential prefetch request 202 and remove that address offset 214. As explained further below, not all of the generated address offsets 214 will result in prefetch requests issued to the memory system. Since multiple potential prefetch requests 202 may be based on the same accessed memory address 204, the same memory address 216 may be reconstructed multiple times.

Another example of an address offset generator that may be one of the offset generators 206 employed in the multi-trained scalable prefetcher 200 is a second-best offset (2BO) generator 206(B). The 2BO generator 206(B) determines a second-best address offset 214(B), based on the recent request table 218, which is the next most likely, after the best address offset 214(A), to produce the accessed memory address 204 based on memory addresses 216 of recently prefetched data.

In another example, the multi-trained scalable prefetcher 200 may include an offset generator 206(C), which generates an address offset corresponding to a next line in memory. The next line address offset 214(C) is added to the accessed memory address 204 of the newly received request, and the resulting address is used to generate a potential prefetch request 202 for the next cache line in the memory. The next line address offset may vary depending on a size of a cache line in a processor or memory system.

Still another example in FIG. 2 is the offset generator 206(D) among the offset generators 206. The offset generator 206(D) generates a spatial address offset based on a pattern of data stored in a memory or a pattern of data organization in the memory, for example. For example, the data pattern may depend on an application being executed or instruction size. Thus, the spatial address offset may be modified to accommodate different patterns. As an example, in response to a fetch for one half of a two (2) cache line block, the offset generator 206(D) may fetch the second half. In this regard, a fetch directed to a second half of a 2 cache line block will result in a prefetch of the first half.

The prefetch generator 210 receives the memory address 204 and a plurality of address offsets 214 and generates potential prefetch requests 202 directed to one or more prefetch addresses, where each of the prefetch addresses is determined based on the memory address 204 and one of the plurality of address offsets 214 according to each of the offset generators 206(A)-(D).

With continuing reference to FIG. 2, the TO generator 212 also includes a learning circuit 224 coupled to the recent request table 218. The BO generator 206(A) and the 2BO generator 206(B) in the learning circuit 224 use the list of recent memory addresses 216 stored in the recent request table 218 to identify the best address offset 214(A) and the second best address offset 214(B).

It can be expected that, even though the plurality of address offsets are generated by different respective algorithms, some of the potential prefetch requests 202 will be directed to the same prefetch address (i.e., two or more of the offset generators 206(A)-(D) may independently generate prefetch requests that target the same actual memory address). In some situations, redundant prefetch requests (e.g., based on the same or similar address offsets from more than one of the offset generators 206) may be resolved or reduced to a single prefetch request. Alternatively, multiple redundant prefetch requests may be generated.

Generating multiple prefetch requests to various memory locations, which may be non-overlapping, partially overlapping, or fully overlapping, increases a probability that data requested by the processor will be present in the L2 cache when a request is issued for such data. In this manner, the multi-trained scalable prefetcher 200 provides a performance improvement to the processor. It should be understood that the use of the multi-trained scalable prefetcher 200 is not limited to the example discussed above involving L2 caches and may extend to a prefetcher for a cache or memory at any level of a memory system. Though some or most of the data received due to the plurality of prefetches may not ever be accessed by the processor, the unneeded data can be easily purged and overwritten.

However, another consequence of generating multiple prefetch requests to several different addresses is an increase in congestion on the data interface over which the prefetch request buffer transmits the potential prefetch requests 202 to the memory system. Thus, at times it may be beneficial to stop sending potential prefetch requests 202 to the prefetch request buffer entirely or to scale the number of prefetch requests up or down (e.g., increase or decrease the number of potential prefetch requests 202 provided to the prefetch request buffer) according to a level of activity on the data interface (e.g., how busy the data interface is). Control of the number of potential prefetch requests 202 provided to the prefetch request buffer is scaled by a prefetch scaling circuit 226. Thus, the prefetch scaling circuit 226 receives the activity level indicator 208, indicating a level of activity on the data interface to the memory system and determines how many of the potential prefetch requests 202 will actually be forwarded. The scaled prefetch requests 228 are the potential prefetch requests 202 that are forwarded by the prefetch scaling circuit 226 based on the activity level indicator 208.

The prefetch scaling circuit 226 may receive potential prefetch requests 202 directed to prefetch addresses that are based on the address offsets from all of the offset generators 206 but may only send some or none of them to the prefetch request buffer depending on the activity level indicator 208. The prefetch scaling circuit 226 determines which of the potential prefetch requests 202 should be sent in the situation of a higher activity level on the data interface. In this regard, the prefetch scaling circuit 226 considers priorities 230 associated with each of the offset generators 206 and determines which of the potential prefetch requests 202 will be included in the scaled prefetch requests 228 provided to the prefetch request buffer based on the respective priorities associated with each of the offset generators 206(A)-206(D).

In other words, in times of low activity on the data interface, the scaled prefetch requests 228 may include most or all of the potential prefetch requests 202. Whereas, in times of high activity on the data interface, the number of scaled prefetch requests 228 is reduced to a smaller number of potential prefetch requests 202 based on address offsets from higher priority offset generators 206. In some cases, none of the potential prefetch requests 202 are sent to the prefetch buffer. Depending on data interface activity level, the scaled prefetch requests 228 may include all, some or none of the potential prefetch requests 202. Priorities 230 for the offset generators 206 may be received from an external source, preset in advance, or dynamically programmed in the prefetch scaling circuit 226. In the case of redundant requests to a same prefetch address, the request from a higher priority address offset generator may be provided to the prefetch request buffer.

The data interface may also be referred to as a data bus or mesh. In one example, an activity level indicator is referred to as CBUSY. In one example, the activity level indicator 208 may be a two-bit binary signal having a total of four (4) possible states, each indicating a level of activity of the data interface at a given time. At each of the activity levels 0-3, the prefetch scaling circuit 226 determines which prefetch requests to forward to the prefetch request buffer, depending on the respective priority levels of the offset generators 206. For example, with the activity level indicator 208 at level 0, prefetch requests may be issued based on the address offsets from all the offset generators 206. In contrast, at level 3, only prefetch requests based on the highest priority offset generator 206 (e.g., BO generator 206(A)) are issued. In some examples, no prefetch requests are issued when the activity level indicator 208 is at the highest level (e.g., level 3).

The prefetch scaling circuit 226 provides prefetch address information 232 to the address reconstructor 220, indicating which of the potential prefetch requests 202 were sent to the prefetch request buffer so the address reconstructor 220 can determine which address offset to subtract from the fetched memory address 222.

There may be any number of address offset generators employed in the multi-trained scalable prefetcher 200. Thus, the number of activity levels indicated by the activity level indicator may not correspond to the number of address offsets generated. For reasons that may be applicable to prefetch requests and/or for other reasons, a finer resolution of the activity level indication may be needed. In one exemplary aspect, the level indicated by the activity level indicator may be tracked over time, and such historical information, in conjunction with other environmental information in the processor or memory system, may be used to determine more activity levels (e.g., with higher resolution). Prefetch requests may be controlled according to the priorities of the address request generators and the additional activity levels in any suitable manner.

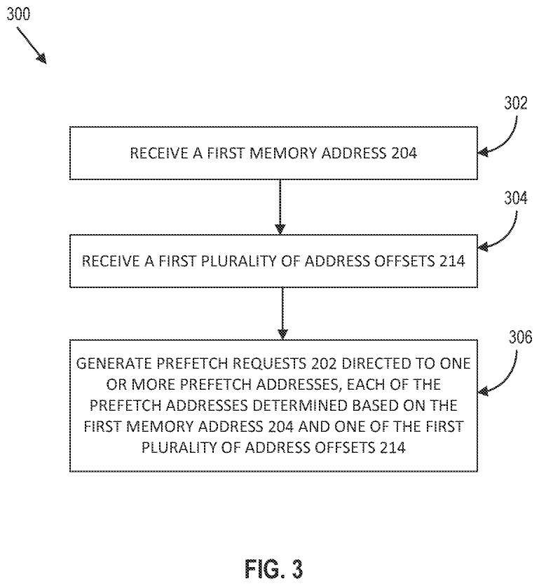

FIG. 3 is a flow chart illustrating a method of generating prefetch requests 202 in a memory system. The method includes receiving a first memory address 204 (block 302) and receiving a first plurality of address offsets 214 (block 304). The method also includes generating potential prefetch requests 202 directed to one or more prefetch addresses determined based on the first memory address 204 and one of the first plurality of address offsets 214 (block 306). The method further includes generate scaled prefetch requests 228 based on an activity level of a data interface and priorities associated with the address offsets 214 (block 308).

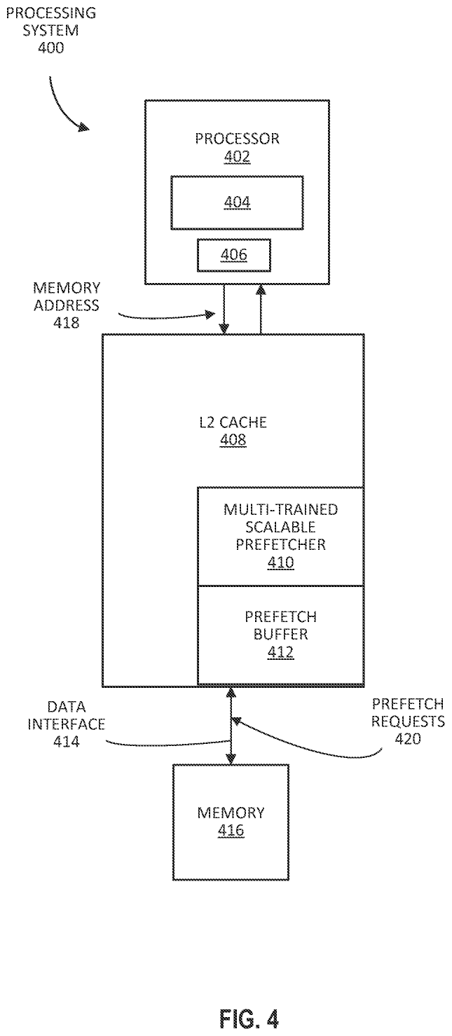

FIG. 4 is a block diagram of a processing system 400, including the multi-trained scalable prefetcher 200 of FIG. 2. The processing system 400 includes a processor 402, further including a processor core 404, and an L1 cache 406. The processing system 400 also includes an L2 cache 408 and a multi-trained scalable prefetcher 410. The processing system 400 also includes a prefetch request buffer 412 coupled to a data interface 414, which is further coupled to other caches and memory 416 of a memory system. The processor core 404 executes instructions for manipulating data. Both the instructions and the data may be stored in the L1 cache 406. When the processor core 404 requests data that is not in the L1 cache 406, a memory address 418 is provided to the L2 cache 408. When the L2 cache 408 indicates a miss at the memory address 418 or a hit and the prefetch bit is set, the multi-trained scalable prefetcher 410 sends a plurality of prefetch requests 420 to the prefetch request buffer 412.

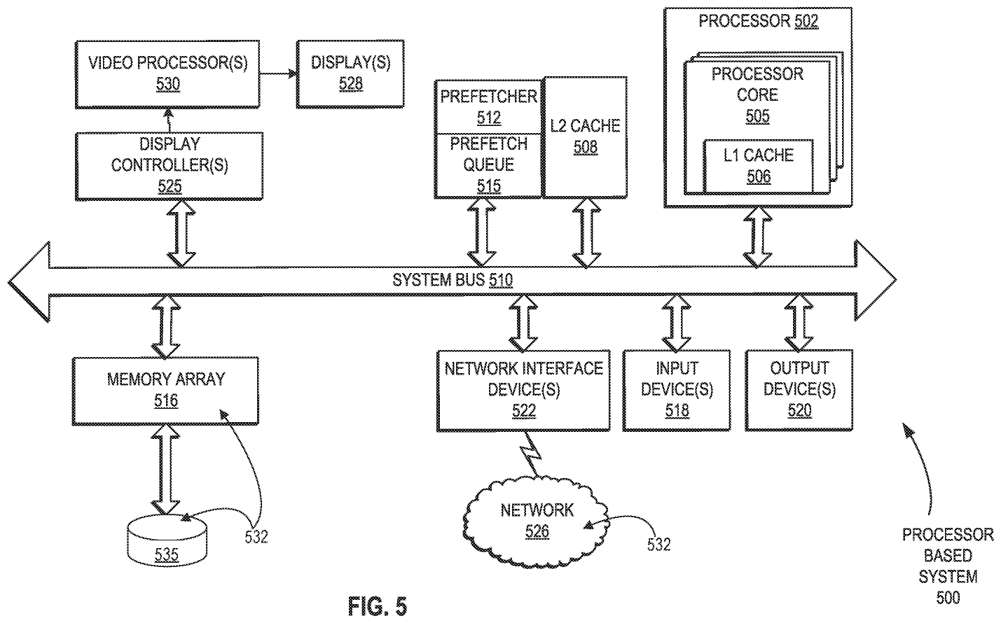

FIG. 5 is a block diagram illustrating an example of a processor-based system 500 that can include a computing system 502, like the processor 302 in FIG. 3, as a non-limiting example. The computing system 502 includes one or more processor cores 505, each including a level one (L1) cache 506. The processor cores 505 request data from their corresponding L1 cache 506. When the requested data is not contained in the L1 cache 506 (e.g., a miss occurs), a request for the data is forwarded to an L2 cache 508 through communications on the system bus 510. Associated with the L2 cache 508, in this example, the prefetcher 512 receives the memory address of the data requested from the L2 cache and generates a plurality of prefetch requests that may be forwarded to the prefetch request buffer 515, depending on a level of activity on the system bus 510.

The system bus 510 may be busy with communications between other devices coupled to the system bus 510. As illustrated in FIG. 5, these devices can include the memory system 516, to which the prefetch requests may be directed. The devices coupled to the system bus 510 may also include one or more input devices 518, one or more output devices 520, one or more network interface devices 522, and one or more display controllers 525, as examples. The input device(s) 518 can include any type of input device, including, but not limited to, input keys, switches, voice processors, etc. The output device(s) 520 can include any type of output device, including, but not limited to, audio, video, other visual indicators, etc. The network interface device(s) 522 can be any device(s) configured to allow an exchange of data to and from a network 526. The network 526 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 522 can be configured to support any type of communications protocol desired.

The computing system 502 may also be configured to access the display controller(s) 525 over the system bus 510 to control information sent to one or more displays 528. The display controller(s) 525 sends information to display(s) 528 to be displayed via one or more video processors 530, which process the information to be displayed into a format suitable for the display(s) 528. The display(s) 528 can include any type of display, including, but not limited to, a cathode ray tube (CRT), a liquid crystal display (LCD), a plasma display, a light emitting diode (LED) display, etc.

The memory system 516 of the processor-based system 500 may include a set of computer-readable instructions 532 stored in a non-transitory computer-readable medium 535 (e.g., a memory). Also, other components of the processor-based system 500 in FIG. 5 can include computer-readable instructions 532 stored in a non-transitory computer-readable medium 535 (e.g., a memory) that can be accessed by the computing system 502 to be executed to perform tasks that require instructions and/or data from the memory system 516. These computer-readable instructions 532 can be stored in the non-transitory computer-readable medium 535. The computer-readable instructions 532 may further be transmitted or received over the network 526 via the network interface device 522, such that the network 526 includes the non-transitory computer-readable medium 535. The computer-readable instructions 532 may further be transmitted or received from the input device 518.

While the non-transitory computer-readable medium 535 is shown in an exemplary embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. For example, the initiator and target devices described herein may be employed in any circuit, hardware component, integrated circuit (IC), or IC chip. A processor is a circuit that can include a microcontroller, a microprocessor, or other circuits that can execute software or firmware instructions. A controller is a circuit that can include a microcontroller, a microprocessor, and/or dedicated hardware circuits (e.g., a field programmable gate array (FPGA)) that do not necessarily execute software or firmware instruction. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic devices, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of non-transitory computer-readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. A memory system, comprising a prefetcher configured to:
receive a first memory address of requested data;
generate a first plurality of address offsets; and
generate a first plurality of prefetch requests directed to one or more prefetch addresses, each of the one or more prefetch addresses based on the first memory address and a corresponding one of the first plurality of address offsets.

2. The memory system of claim 1, the prefetcher further configured to:
receive an activity level indicator indicating an activity level of a data interface; and
based on the activity level indicator, provide a second plurality of prefetch requests among the first plurality of prefetch requests to a prefetch request buffer.

3. The memory system of claim 2, further configured to determine the second plurality of prefetch requests based on priority levels corresponding to each of the first plurality of address offsets.

4. The memory system of claim 1, the prefetcher comprising:
a plurality of offset generators configured to generate the first plurality of address offsets, wherein each of the plurality of offset generators employs one of a plurality of algorithms each distinct from the others.

5. The memory system of claim 4, the prefetcher further configured to:
receive fetched memory addresses of data fetched in response to previous prefetch requests;
determine previous memory addresses based on the fetched memory addresses and the first plurality of address offsets; and
determine a best offset comprising one of the first plurality of address offsets most likely to produce, in combination with one of the previous memory addresses, the first memory address.

6. The memory system of claim 5, the prefetcher further comprising:
a recent request table circuit configured to store the previous memory addresses; and
a learning circuit configured to determine, based on the previous memory addresses stored in the recent request table, the best offset among the first plurality of address offsets.

7. The memory system of claim 6, the prefetcher further configured to delete a duplicate prefetch request of the first plurality of prefetch requests having a same prefetch address as another one of the first plurality of prefetch requests.

8. The memory system of claim 5, the prefetcher further comprising a plurality of offset generators configured to generate the first plurality of address offsets.

9. The memory system of claim 8, the plurality of offset generators comprising a best offset generator configured to generate the best offset.

10. The memory system of claim 9, the plurality of offset generators further comprises at least one of:
a second-best offset generator configured to generate a second best offset comprising one of the first plurality of address offsets second most likely to produce an address offset resulting in the first memory address based on one of the previous memory addresses;
a next-line address offset generator configured to generate a next-line address offset based on a size of a line of memory; and
a spatial address offset generator configured to generate a spatial address offset based on a storage pattern.

11. A method of prefetching in a memory system, the method comprising:
receiving a first memory address of requested data;
generating a first plurality of address offsets; and
generating a first plurality of prefetch requests directed to one or more prefetch addresses, each of the one or more prefetch addresses based on the first memory address and a corresponding one of the first plurality of address offsets.

12. The method of claim 11, further comprising:
receiving an activity level indicator indicating an activity level of a data interface; and
based on the activity level indicator, providing a second plurality of prefetch requests among the first plurality of prefetch requests to a prefetch request buffer.

13. The method of claim 12, further comprising determining the second plurality of prefetch requests based on priority levels corresponding to each of the first plurality of address offsets.

14. The method of claim 11, further comprising:
generating the first plurality of address offsets in a plurality of offset generators, wherein each of the plurality of offset generators employs one of a plurality of algorithms each distinct from the others.

15. The method of claim 14, further comprising:
receiving fetched memory addresses of data fetched in response to previous prefetch requests;
determining previous memory addresses based on the fetched memory addresses and the first plurality of address offsets; and
determining a best offset comprising one of the first plurality of address offsets most likely to produce, in combination with one of the previous memory addresses, the first memory address.

16. The method of claim 15, further comprising:
storing the previous memory addresses in a recent request table circuit; and
determining, based on the previous memory addresses stored in the recent request table, the best offset among the first plurality of address offsets.

17. The method of claim 16, further comprising deleting a duplicate prefetch request of the first plurality of prefetch requests having a same prefetch address as another one of the first plurality of prefetch requests.

18. The method of claim 15, further comprising generating, in a plurality of offset generators, the first plurality of address offsets.

19. The method of claim 18, determining the best offset in a best offset generator among the plurality of offset generators.

20. The method of claim 19, further comprising generating, in the plurality of offset generators, at least one of:
a second best offset comprising one of the first plurality of address offsets second most likely to produce an address offset resulting in the first memory address based on one of the previous memory addresses;
a next-line address offset based on a size of a line of memory; and
a spatial address offset based on a storage pattern.

21. A non-transitory computer-readable medium having stored thereon computer-executable instructions which, when executed by a processor, cause a memory system to:
receive a first memory address of requested data;
generate a first plurality of address offsets; and
generate a first plurality of prefetch requests directed to one or more prefetch addresses, each of the one or more prefetch addresses based on the first memory address and a corresponding one of the first plurality of address offsets.
